(19) United States
(12) Patent Application Publication
(10) Pub. No.: US 2024/0313533 A1
(43) Pub. Date: Sep. 19, 2024

(54) Zonal Machine Learning-based Protection for Distribution Systems

(71) Applicant: UNM Rainforest Innovations, Albuquerque, NM (US)

(72) Inventors: Ali Bidram, Albuquerque, NM (US); Matthew Reno, Albuquerque, NM (US); Binod Poudel, Albuquerque, NM (US); Adam Summers, Albuquerque, NM (US)

(73) Assignee: UNM Rainforest Innovations, Albuquerque, NM (US)

(21) Appl. No.: 18/225,087

(22) Filed: Jul. 21, 2023

Related U.S. Application Data
(60) Provisional application No. 63/391,263, filed on Jul. 21, 2022.

(51) Int. Cl. H02J 3/04; G06N 20/00; H01H 71/74

(52) U.S. Cl. CPC H02J 3/04; G06N 20/00; H01H 71/74

(57) ABSTRACT

A system, device and method that provides for the addition of Local Adaptive Modular Protection (LAMP) units to the protection system to guarantee its reliable operation under extreme events when the operation of the APS is compromised.

### RELATED APPLICATIONS

This application claims priority to U.S. Provisional Application No. 63/391,263, filed on Jul. 21, 2022, which is incorporated herein in its entirety.

### STATEMENT REGARDING FEDERALLY SPONSORED RESEARCH & DEVELOPMENT

This invention was made with government support by the Department of Energy grant DE-NA0003525 and DOE-SNL, grant 36533. The government has certain rights in the invention. The government has certain rights in the invention.

### INCORPORATION BY REFERENCE OF MATERIAL SUBMITTED ON A COMPACT DISC

Not applicable.

### BACKGROUND OF THE INVENTION

The protection system is a crucial part of the electric grid for fast detection and isolation of faults. A protection system should satisfy the sensitivity and selectivity requirements. Sensitivity is the ability of the protection system to quickly detect and isolate faults before the power grid's stability margins are violated. Selectivity is the capability of the protection system to isolate the fault such that the least number of loads are affected by a power outage. The role of protection systems is to enhance the power system's reliability and resilience and to avoid major outages with possible cascading effects.

The conventional protection system lacks the intelligence required to modify its actions based on the prevailing system conditions. It uses fixed settings for protective relays that are well-tuned only for fixed and normal operating conditions. However, in a modern distribution system (DS), the operation of the conventional protection system can be highly ineffective due to the high penetration of distributed energy resources (DERs). The introduced challenges stem from the characteristics of fault currents supplied by inverter-based resources (IBRs) which are limited and may only include positive sequence components. Moreover, the existence of DERs along the distribution circuits can potentially impose a reverse power flow condition that endangers the selectivity and sensitivity of the underlying protection system and results in unwanted events like sympathetic tripping.

On the other hand, a modern DS can adopt different circuit topologies to accommodate a reliable and resilient supply of power to critical regions through multiple branches. The topology of a DS refers to the arrangement of physical devices like lines, cables, tie breakers, etc. which render a specific distribution of electric power. However, changes in circuit topology will highly affect the fault currents which deteriorates the performance of protection schemes. To tackle these challenges, adaptive protection is a promising solution to effectively modify protection responses in real-time based on the prevailing system conditions.

Most of the existing adaptive protection schemes (APS) are centralized and based on a set of pre-defined logical rules. An APS highly relies on the communication infrastructure to monitor the latest status of the electric power grid and send appropriate settings to all of the protection relays existing in the grid. This makes an APS highly vulnerable to communication system failures (e.g., broken communication links due to natural disasters as well as wide-range cyber-attacks).

### SUMMARY OF THE INVENTION

In one embodiment, the present invention concerns a system, device and method that provides for the addition of Local Adaptive Modular Protection (LAMP) units to the protection system to guarantee its reliable operation under extreme events when the operation of the APS is compromised. LAMP units operate in parallel with the conventional APS. As a backup, if APS fails to operate because of an issue in the communication system, LAMP units can accommodate reliable fault detection and location on behalf of the protection relay.

In another embodiment, the present invention concerns a system, device, and method for the use of LAMP units to guarantee the reliable operation of the protection system under extreme events when the operation of the APS is compromised. LAMP units operate in parallel with the conventional APS.

In another embodiment, the present invention concerns a system, device, and method for the use of LAMP units wherein each LAMP unit protects its own region, and (ii) provides backup protection for the zones in front of it.

In another embodiment, the present invention concerns a communication-free modular adaptive protection scheme which can detect faults and identify their type based on prevailing circuit condition.

In another embodiment, the present invention concerns a machine learning-based approach which is fully adaptive in that it can intelligently adjust its protection zones based the distribution system's configuration in an online fashion.

In another embodiment, the present invention concerns a protection method that is fully setting-less. This will obviate the requirement of regular protection settings adjustment by protection engineers which is subject to human errors.

In another embodiment, the present invention concerns a system, device, and method for the use of LAMP units wherein each LAMP unit not only protects their assigned primary zone but also provides backup protection for the faults on the neighboring zones. LAMP can provide faster protection without stacked CTI on the backup protection devices.

In another embodiment, the present invention concerns a protection scheme wherein the local adaptive protection approach includes three main classifiers, i.e., circuit topology estimator, fault type classifier, and fault zone classifier.

In another embodiment, the present invention concerns the use of LAMP units to significantly improve the reliable operation of the protection system under extreme events.

In another embodiment, the present invention concerns LAMP units adapted to operate in parallel with the conventional relays that are coordinated by APS. If an issue is identified in the communication system of APS, the LAMP units will act as a reliable backup to adaptively protect their assigned equipment under different circuit conditions.

In another embodiment, the present invention provides an approach that utilizes SVM as a machine learning algorithm to (i) estimate the circuit topology, (ii) identify fault type, and (iii) detect fault zone. For each LAMP unit, two or more zones may be defined. The faults within Zone 1 are cleared instantaneously while the faults in Zone 2, as well as others, are cleared with some delay. The defined zones help with the selectivity of the protection system in clearing faults where each LAMP unit not only protects its own equipment but also provides backup protection for the neighboring equipment. The performance of the proposed APS is verified using IEEE 123 node test system. The simulation results verify the accuracy of LAMP units in circuit topology estimation, fault type classification, and zone classification.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 shows an embodiment of the present invention concerning a LAMP in the distribution system.

FIG. 2 shows an embodiment of the present invention concerning LAMP protection zones.

FIG. 3 shows an embodiment of the present invention concerning a LAMP architecture.

FIG. 4 shows a SVM training and testing procedure.

FIG. 5 shows the LAMPs' zone 1 boundaries in configuration 1 of IEEE 123 node system as an example of how LAMPs' zone 1 boundaries are defined considering the DS configuration.

FIG. 6 shows the LAMPs' zone 1 boundaries in configuration 2 of IEEE 123 node system as an example of how LAMPs' zone 1 boundaries are defined considering the DS configuration.

FIG. 7 shows the LAMPs' zone 1 boundaries in configuration 3 of IEEE 123 node system as an example of how LAMPs' zone 1 boundaries are defined considering the DS configuration.

FIG. 8 shows the LAMPs' zone 1 boundaries in configuration 4 of IEEE 123 node system as an example of how LAMPs' zone 1 boundaries are defined considering the DS configuration.

FIG. 9A shows Confusion matrix for circuit topology estimation results at LAMP R4

FIG. 9B shows Confusion matrix for circuit topology estimation results at LAMP R6.

FIG. 9C shows Confusion matrix for circuit topology estimation results at LAMP RTL3.

FIG. 9D Confusion matrix for circuit topology estimation results at LAMP RTL4.

FIG. 10 shows the Fault type classification results for LAMP R1.

FIG. 11 shows the coordination of conventional APS for IEEE 123 node system in Configuration 1 when correct time over current relay settings are used.

### DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

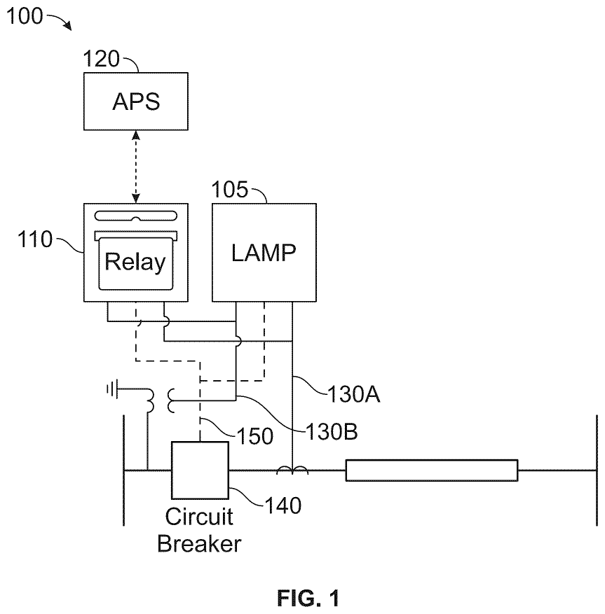

In one embodiment of the present invention, as shown in FIG. 1, distribution system 100 includes at least one LAMP unit 105 that is installed in parallel with the conventional protection relay 110 used with convention adaptive protection system (APS) 120.

LAMP 105 is configured to operate all the time and provides a redundancy for the adaptive protection of DS 100. In particular, if there is a communication system outage, the conventional APS 120 will be ineffective, and LAMP 105 can effectively detect and isolate faults. FIG. 1 further shows the location of each LAMP unit 105 in system 100. As seen, LAMP 105 is connected to local current transformer 103A and voltage transformer 130B. When a fault is detected requiring isolation LAMP 105 is configured to send a trip command to the local circuit breaker 140 via hard wire 150.

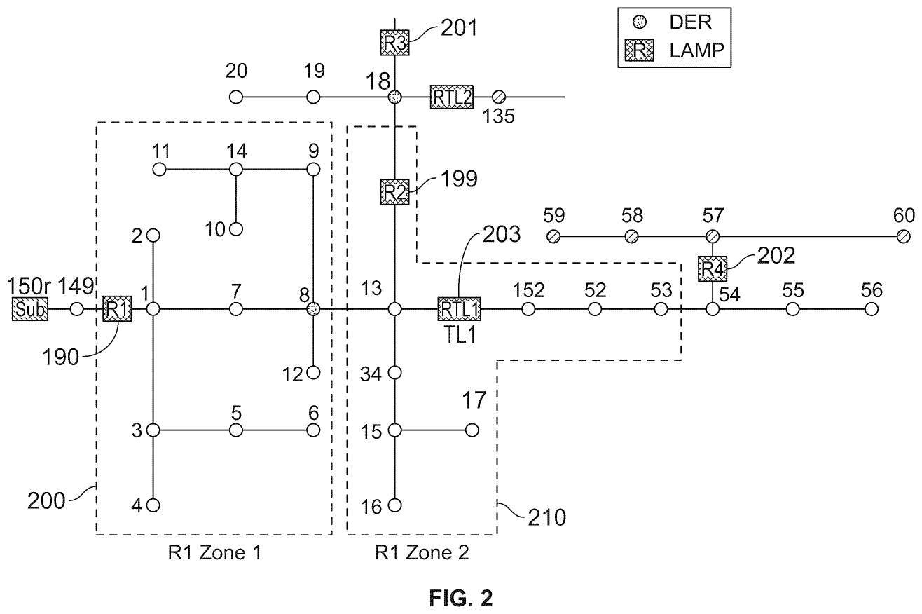

To show the proposed LAMP functionality, a portion of IEEE 123 bus system shown in FIG. 2 is considered. In yet another embodiment, each LAMP unit can accommodate setting-less protection for the system. Each LAMP unit is associated with a predetermined operating region. For example, in FIG. 2, LAMP R1's (190) region 200 includes all the lines/cables and buses 1-14 between Bus 149 as the start bus and Bus 13 as the end bus at which the forward LAMP R2 (199) is located. Each LAMP is expected to provide (i) primary protection for its own region and (ii) backup protection for the LAMP units in front of it Thus, as shown in FIG. 2, LAMP 190 primary protection for its own region 200 and (ii) backup protection for the LAMP units in front of it, such as LAMP R2 199.

To accommodate a well-coordinated LAMP operation, a preferred embodiment of the present invention utilizes two protection zones for each LAMP unit. For the protection Zone 1 (200), LAMP R1 190 operates instantaneously while, for Zone 2 (210), LAMP R1 190 operates with some delay to guarantee an acceptable Coordination Time Interval (CTI) margin with the LAMP R2 199 and LAMP RTL1 203 in front of it. This delay depends on the utility practice. As an exemplar, a delay of 0.2 sec was used for the backup protection.

To avoid errors in the LAMP units from operating for the faults occurring in the neighboring regions, the present invention further includes branches connected to the remote bus of the LAMP region in the protection Zone 2. By doing so, the LAMP units are well-coordinated, and they avoid instantaneous operation for faults on neighboring lines/cables.

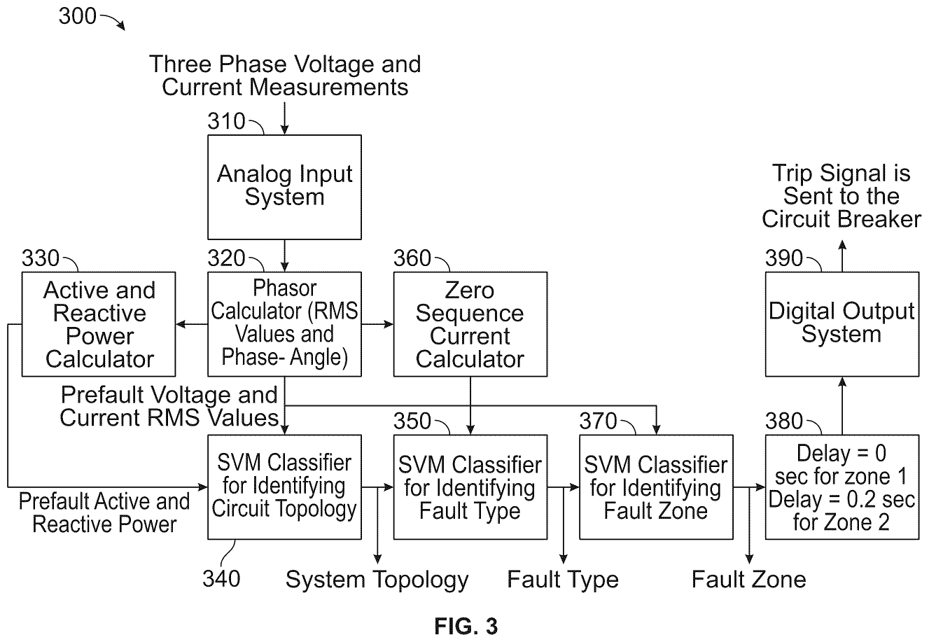

The LAMP architecture is shown in FIG. 3. As illustrated in FIG. 3, LAMPs are expected to (i) detect circuit topology, (ii) identify the fault type (e.g., 3-phase to ground, phase-to-phase, and bolted and resistive single phase and double phase to ground faults), and (iii) identify if the fault is within their primary or backup zones.

The circuit topology estimation is performed using pre-fault data. In fact, LAMPs keep monitoring the circuit topology during system normal conditions. So, once a fault occurs, a LAMP is already aware of the circuit topology. To perform the classification of fault types and fault zones, and support vector machine (SVM) classifier is utilized. SVM is a memory efficient classification approach that can classify the inputs with a very high accuracy. Once the fault type is identified, the zone classification is performed for that specific fault type.

### Training Procedure

The proposed local adaptive protection approach of the present invention includes three main classifiers, i.e., circuit topology estimator, fault type classifier, and fault zone classifier. The training procedure for each of these classifiers is provided as follows:

1) Circuit Topology Estimator 340: The circuit topology estimation is performed during the normal operating condition of system using SVM. As shown in FIG. 3, the input to the SVM classifiers includes the prefault three-phase voltage and current 300 collected through the analog input system 310. Phasor calculator 320 determines the root-mean-square (RMS) value and phase angle of the three-phase voltage and current measurements.

Active and reactive calculator 330 receives input from phasor calculator 320 and sends prefault active and reactive power measured at the LAMP location to SVM classifier 340 which is used to determine the topology of the DS system. The topology of DS refers to the arrangement of physical devices like lines, cables, tie breakers. However, the change of circuit topology can significantly change the DS measurements (e.g., active, and reactive power flow or current and voltage measured at different locations of the system). In fact, the changes observed in these measurements can be used as a local way of detecting the circuit topology. The training and testing data for the circuit topology estimator are gathered by simulating the IEEE 123 node test system in OpenDSS. To train the SVM classifier 340, all different circuit topologies of DS are simulated using variable load and IBR profiles for a period of one year assuming a system normal condition. The training dataset is selected out of this simulated data. By doing so, the impact of seasons on the load and generation profiles are accounted for.

2) Fault Type Classifier 350: The fault type classifier utilizes another SVM classifier 350 to identify fault type (i.e., three-phase to ground, single line to ground, etc.) based on the locally measured three phase voltage and current RMS values as well as the zero-sequence current from calculator 360. The RMS values of postfault current and voltages and zero sequence current measurement are the ones used in conventional digital relays for fault detection. To train the SVM classifier 350, different types of faults are required to be simulated at different locations along each line segment within the operating zones of each LAMP unit. A line segment denotes a branch connecting two nodes of the system. The simulated faults include bolted and resistive ground faults. Faults are applied at every 5% of the line segments' length. Out of the simulated fault scenarios, 60% of them are randomly selected for training and the rest are used for testing the SVM classifier 350.

3) Fault Zone Classifier 370: The fault zone classification is performed after the fault type is detected. For each fault type, the simulated fault scenarios at different locations along each line segment are used to train the machine learning classifier 370. The data is labeled as Zone 1 and Zone 2 based on the location of fault. Similar to the fault type classifier, the locally measured three phase voltage and current RMS values from calculator 320 as well as the zero-sequence current from calculator 360 are used as the inputs to the fault zone SVM classifier 370. Similar to the fault type classifier 350, an embodiment of the present invention simulates faults at every 5% of the line segments in any power system short circuit solver (e.g., PSS® CAPE) and randomly selects 60% of simulated data for training.

LAMP determines if the fault is in Zone 1 or Zone 2. For a zone 1 fault the digital output system 390 sends a trip signal to a circuit breaker with no delay. A zone 2 fault results in a predetermined delay before a trip signal is sent.

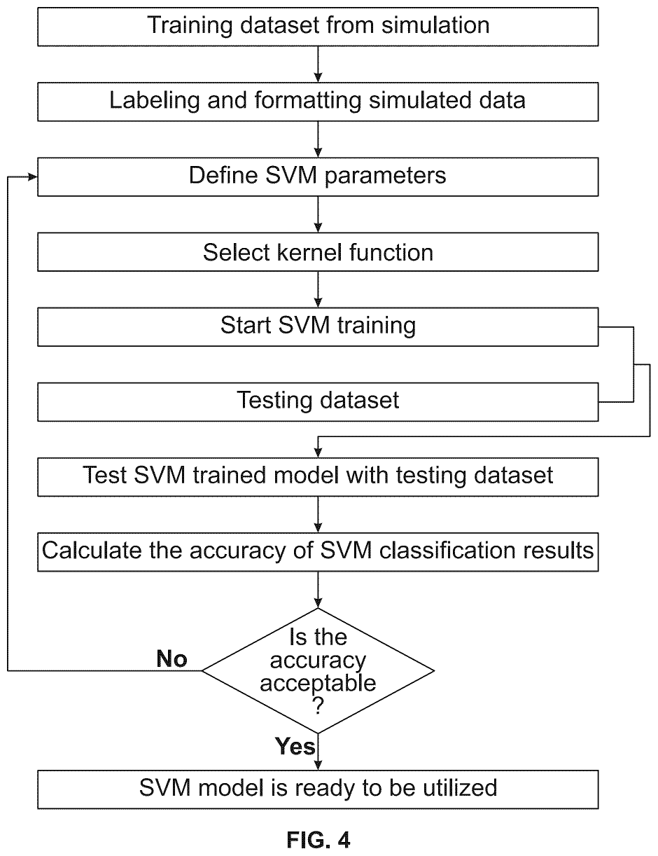

The SVM operation flowchart including its testing and training procedure is provided in FIG. 4.

### Lamp's Response Time and Cost:

The major portion of LAMP unit response time will include the time to calculate the RMS value of the measurements (three-phase voltage and current). This usually requires around half a cycle (8 ms in a 60 Hz system). The response time of the machine learning algorithms depends on the microprocessor used for LAMP implementation. In an approach used by an embodiment of the present invention, the topology estimation is performed during system normal conditions. After the fault occurs, the SVM classifier 350 for fault type identification first runs, and then the SVM 370 for fault zone detection is deployed. It should be noted that each LAMP unit can be implemented on a microprocessor. The implementation cost of the proposed approach will be only limited to the cost of microprocessors hosting LAMP units. Each LAMP unit can utilize the existing current and voltage transformers for current and voltage measurements.

### Simulation Results

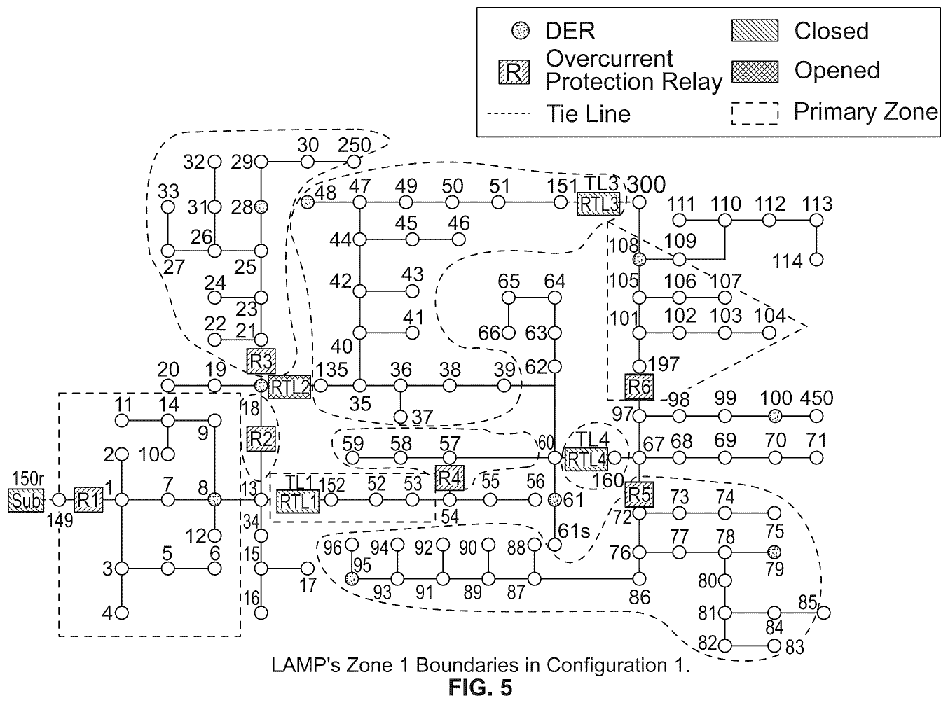

To verify the effectiveness of LAMP modules, IEEE 123 node test system, shown in FIG. 5, is slightly modified by adding tie lines, IBRs, and LAMP units. The modifications on the original test system are as follows:

1) Four tie lines are included in the test system to accommodate four different circuit topologies; It was assumed that in each configuration at least one of the tie lines is open to avoid a loop in the circuit. The four circuit configurations are listed in Table 1.

TABLE 1
List of circuit configurations

| Configuration | TL1 | TL2 | TL3 | TL4 |
|---|---|---|---|---|
| Configuration 1 | Close | Open | Close | Close |
| Configuration 2 | Close | Close | Open | Close |
| Configuration 3 | Close | Close | Close | Open |
| Configuration 4 | Open | Close | Close | Close |

2) Nine IBRs are added to the original test system to simulate a distribution system with high penetration of IBRs. The specifications and ratings of these IBRs are provided in Table 2. This table includes the inverters' DC and AC ratings, types, and maximum fault current contribution. It is assumed that the inverter's maximum fault current contribution is equal to 140% of the inverter's current rating.

TABLE 2
IBRs' specifications

| Bus Number | 8 | 18 | 28 | 48 | 61 | 79 | 95 | 100 | 108 |
|---|---|---|---|---|---|---|---|---|---|
| IBR's AC Rating (kVA) | 500 | 700 | 500 | 1000 | 500 | 500 | 1000 | 500 | 500 |
| IBR's DC Rating (kW) | 600 | 840 | 600 | 1200 | 600 | 600 | 1200 | 600 | 600 |
| Maximum Fault Current (A) at 4.16 kV | 97.15 | 136 | 97.15 | 194.3 | 97.15 | 97.15 | 194.3 | 97.15 | 97.15 |

3) Ten LAMP units are located on the different cables of the circuit. Out of the ten LAMP units, four of them are located on the tie lines. In all configurations, only nine LAMP units are operational as one tile line is always out of service.

### Lamp Zones for all Four Configurations

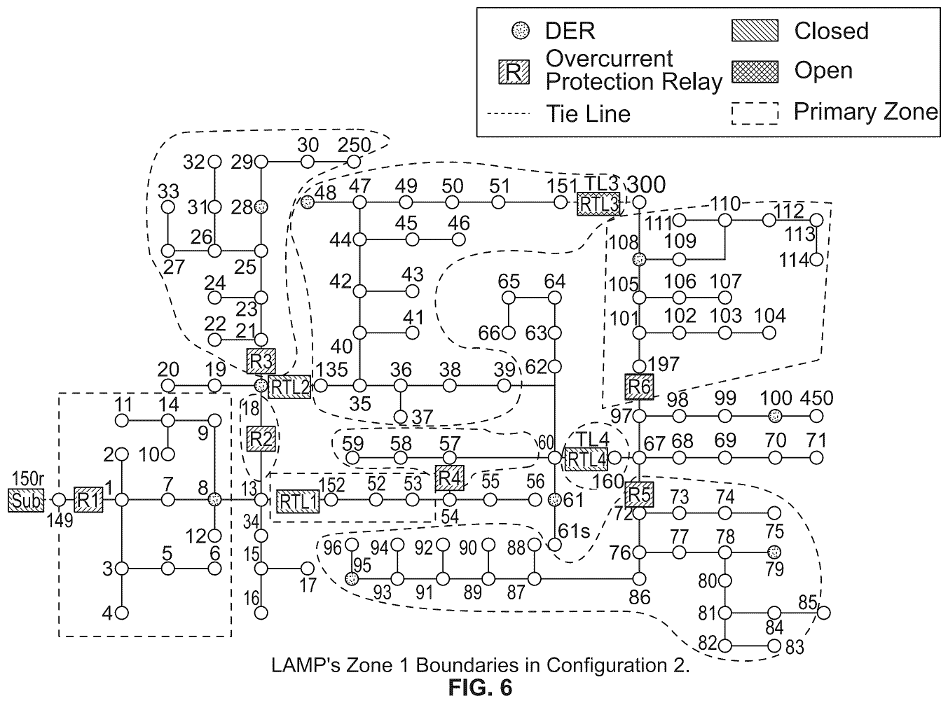

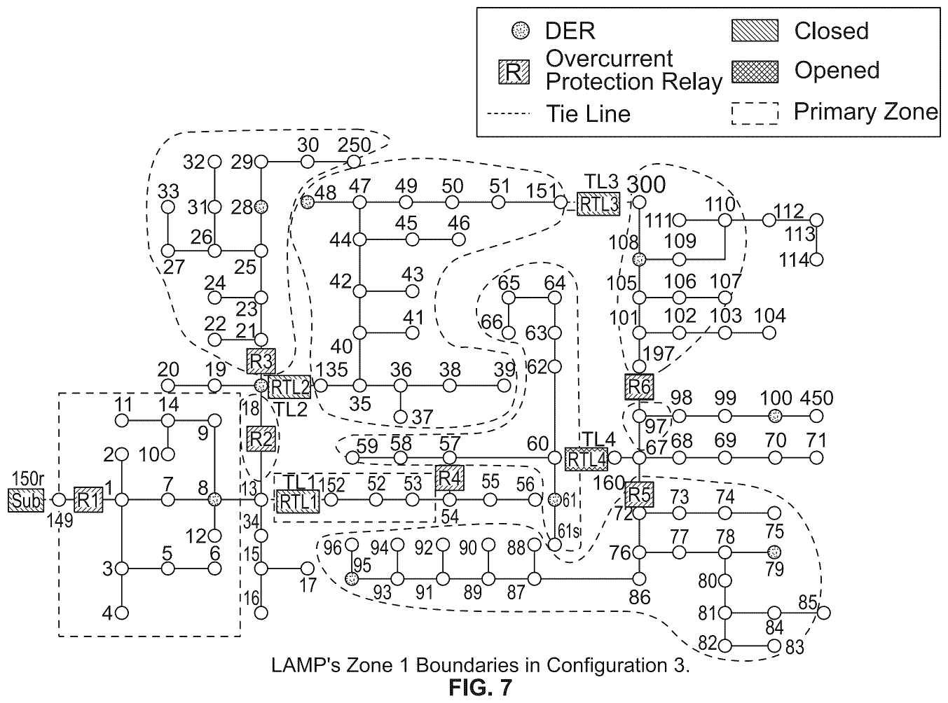

The simulation results consider four different circuit topologies which are shown in FIGS. 5 to 8. In these figures, Zone 1 of all LAMPs is only highlighted. It should be noted that Zone 2 of each LAMP unit includes the branches and nodes of its region that are not included in Zone 1 and the whole Zone 1 of the LAMPs in front of it.

As seen in these figures, the change of circuit configuration only has an impact on the zone definition of LAMPs R4, R6, RTL3, and RTL4. For other LAMP units, the change of circuit topology does not have any impact on their Zone 1 boundaries. Moreover, for the LAMP units that are located at the end of the feeder and don't see any other LAMPs in front of them, only one zone is defined (e.g., R3, R5, and RTL3 in Configuration 1).

### SVM Classification Results

### Circuit Topology Estimation

Each LAMP unit utilizes the normal operating condition (prefault) data to estimate the prevailing circuit topology of the system. The system consists of IBRs as shown in Table 2. The prefault voltage, current, active power, and reactive power measurements at the LAMP location are utilized as the inputs to the SVM to estimate the corresponding circuit topology. The data includes measurements for all four configurations. The data collected on even weeks are used for training and the data collected on odd weeks are used for testing. The training data are further down-sampled to have only hourly data, i.e., only 19% of data are utilized for training using a function in sklearn. For four configurations, four different class labels are generated by SVM. The SVM classifier uses a linear Kernel function and parameter C in (3) is equal to 0.12. It should be noted that the circuit topology estimation is only performed for LAMPs R4, R6, RTL3, and RTL4. The reason is that the change of circuit topology only has an impact on the zone definition of these LAMP units. This means that other LAMP units are not required to alter their zones definition if the circuit topology changes. This is illustrated in FIGS. 5 to 8. The accuracy of the circuit topology estimation results is provided in Table 3.

TABLE 3
Circuit topology estimation accuracy at different LAMP units.

| LAMP | Accuracy(%) |
|---|---|
| R4 | 99.9947 |
| R6 | 99.9981 |
| RTL3 | 99.9876 |
| RTL4 | 100.0 |

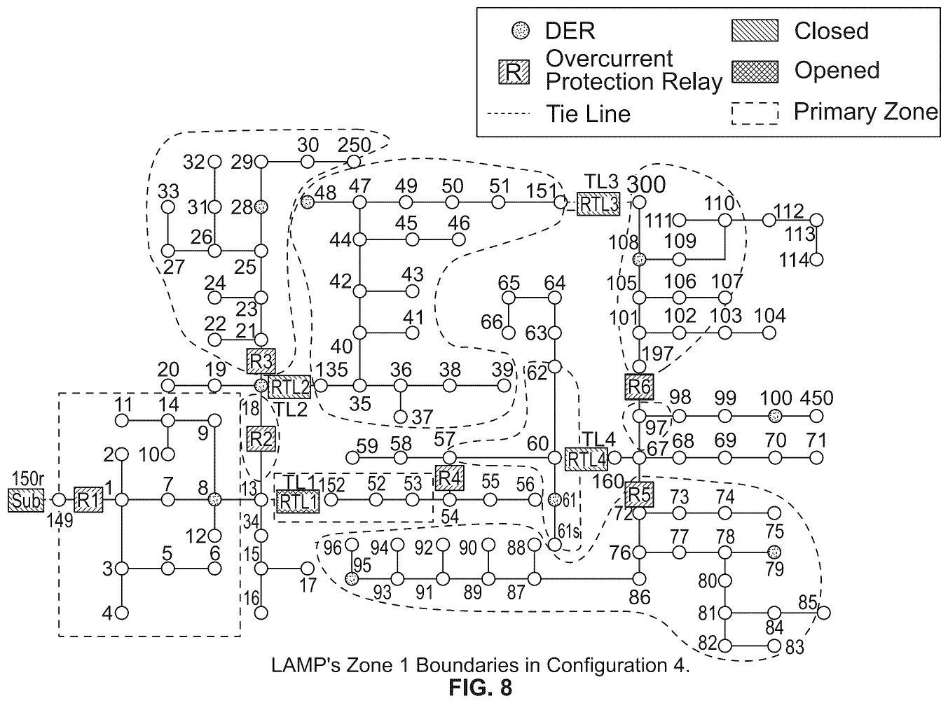

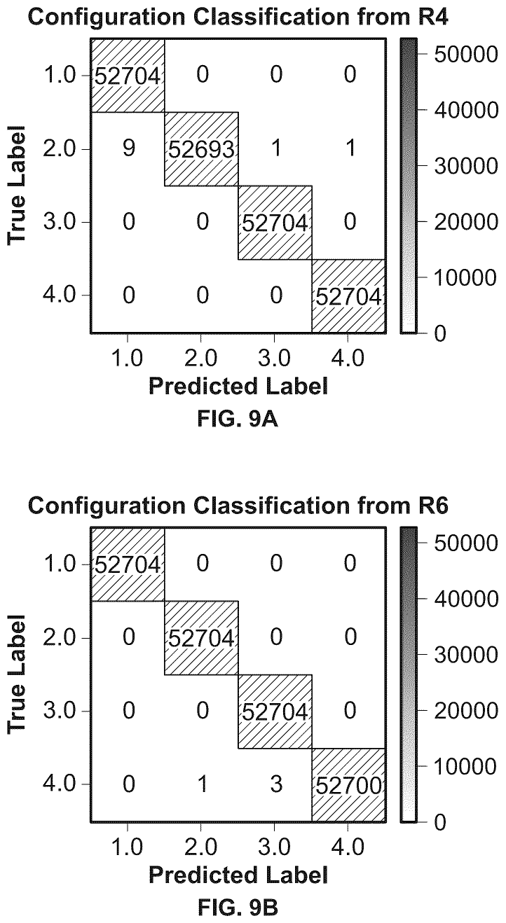

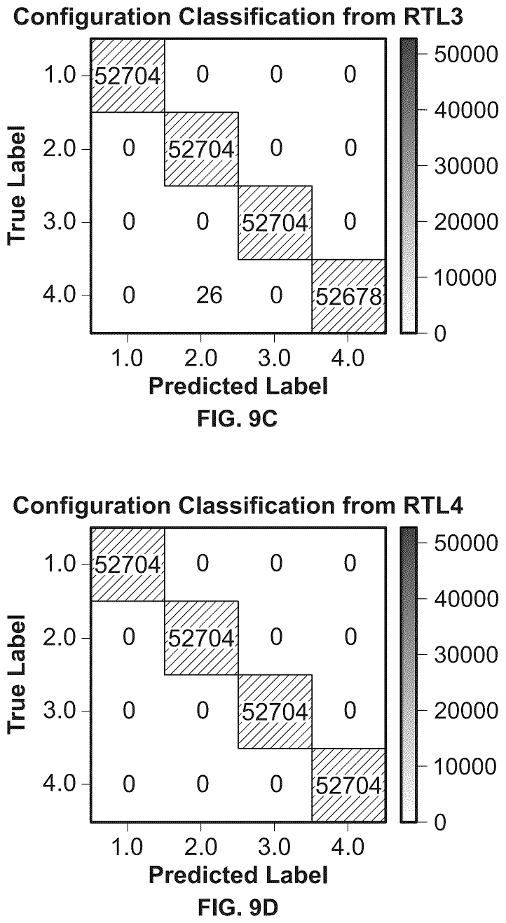

The confusion matrix for the circuit topology estimation results for LAMPs R4, R6, RTL3, and RTL4 are provided in FIGS. 9a-9d. The high accuracy of SVM algorithm using the testing dataset shows that the algorithm is not overfitting.

### Fault Type Classification

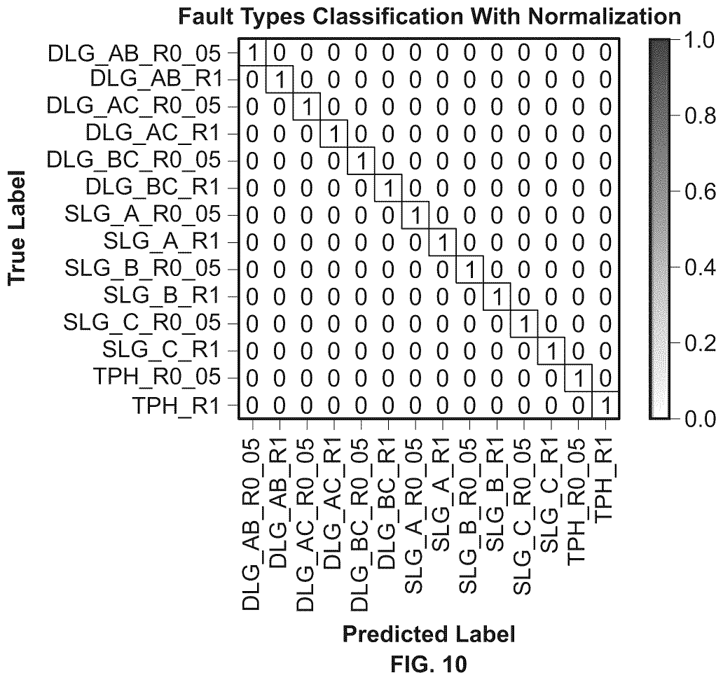

Based on the prevailing circuit topology, the LAMP will identify fault type once a fault occurs. In PSS® CAPE software, seven different types of faults including three phase to ground (TPH), single line to ground (SLG_A, SLG_B, SLG_C), and double line to ground (DLG_AB, DLG_AC, DLG_BC) are simulated at different locations (every 5% of each line segment) within the operating regions of LAMP units. A line segment denotes a branch connecting two nodes of the system. For example, in FIG. 5, the line segments for LAMP R1's Zone 1 include (1,2), (1,3), (3,4), (3,5), (3,6), (1,7), (7,8), (8,12), (8,9), (9,14), (14,10), (14,11) branches. On each line segment, faults are applied on its two terminal nodes as well as at 5%, 10%, . . . , 90%, and 95% of the line segment length. Out of the simulated fault scenarios, 60% of them are used for training and the rest are used for testing. The simulated faults also include bolted and resistive ground faults. The fault resistance is equal to 1 D. The inputs to the fault type classifier are the three-phase voltage and current RMS values as well as the zero-sequence current measured at the location of LAMP unit. The SVM classifier uses a linear Kernel function and parameter C in (3) is equal to 0.12. The fault type classification results render 100% accuracy for all LAMP units. The fault type classification results for LAMP R1 are provided in FIG. 10. The high accuracy of SVM algorithm using the testing dataset shows that the algorithm is not overfitting.

### Zone Classification

Once the fault type is identified at the LAMP unit, zone classification is performed. The inputs to the zone classifier are the three-phase voltage and current RMS values as well as the zero-sequence current measured at the location of LAMP unit. For each of the fault types, the data used to train a machine learning classifier are labeled as Zone 1 and Zone 2. The simulation results utilized for training and testing of the classifier include the faults applied at every 5% of each line segment within Zone 1 and Zone 2 of each LAMP unit. Out of the simulated fault scenarios, 60% of them are used for training and the rest are used for testing. These fault studies are performed on the modified IEEE 123 node system simulated in PSS® CAPE. The SVM classifier uses a linear Kernel function and parameter C in (3) is equal to 0.12. The zone classification results for all four configurations are provided in Tables 4 to 7.

TABLE 4
Zone classification accuracy at different
LAMP units in Configuration 1.

| LAMP | Average Accuracy(%) |
|---|---|
| R1 | 99.7354 |
| R2 | 100 |
| R4 | 100 |
| R6 | 99.3752 |
| RTL1 | 100 |
| RTL4 | 96.1039 |

TABLE 5
Zone classification accuracy at different
LAMP units in Configuration 2.

| LAMP | Average Accuracy(%) |
|---|---|
| R1 | 100 |
| R2 | 100 |
| R4 | 100 |
| RTL1 | 100 |
| RTL4 | 96.10 |

TABLE 6
Zone classification accuracy at different
LAMP units in Configuration 3.

| LAMP | Average Accuracy(%) |
|---|---|
| R1 | 99.9107 |
| R2 | 100 |
| R6 | 95.7741 |
| RTL1 | 95.3202 |
| RTL2 | 100 |
| RTL3 | 98.9766 |

TABLE 7
Zone classification accuracy at different
LAMP units in Configuration 4.

| LAMP | Average Accuracy(%) |
|---|---|
| R1 | 99.9107 |
| R2 | 100 |
| R6 | 96.1277 |
| RTL2 | 100 |
| RTL3 | 99.0316 |
| RTL4 | 100 |

The zone classification results are only provided for the LAMPs that accommodate both Zone 1 and Zone 2. The high accuracy of SVM algorithm using the testing dataset shows that the algorithm is not overfitting.

### LAMP Response Time Subsequent to Fault

A LAMP unit was implemented on a Raspberry Pi microprocessor. The utilized Raspberry Pi has a BCM2835 CPU with Raspbian GNU/Linux 10 operating system. On this Raspberry Pi, the SVM classifiers for fault type and zone detection take 1.5 ms and 1.126 ms to return the results, respectively. This means that after the fault happens and RMS values of measurements are calculated, it will take around 2.626 ms to detect fault type and fault zone in the LAMP unit.

Comparison of SVM with Other Classifiers

Herein, SVM accuracy is compared against other classification algorithms like Nearest Neighbors, Decision Tree, Random Forest, and Naive Bayes. For the fault type classification at RTL1, the accuracy of these techniques is summarized in Table 8. For zone identification at R1, the accuracy of classification algorithms is compared in Table 9. As seen, SVM renders a very good accuracy compared to other classifiers.

TABLE 8
Comparison of SVM With Other Classifiers
for Fault Type Classification at RTL1

| | | Nearest | Decision | Random | Naive |
|---|---|---|---|---|---|
| Classifier | SVM | Neighbors | Tree | Forest | Bayes |
| Accuracy(%) | 100 | 100 | 84.21 | 100 | 100 |

TABLE 9
Comparison of SVM With Other Classifiers
for Fault Zone Classification at R1

| | | Nearest | Decision | Random | Naive |
|---|---|---|---|---|---|
| Classifier | SVM | Neighbors | Tree | Forest | Bayes |
| Accuracy(%) | 99.82 | 98.25 | 99.46 | 99.7 | 96.52 |

### Impact of Topology Change on the Coordination of Conventional APS

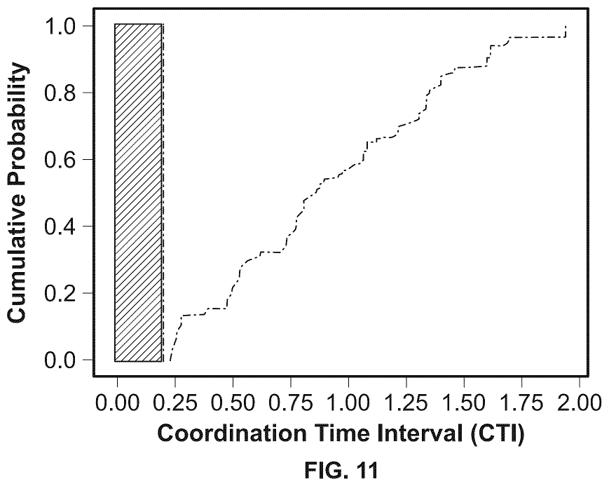

The APS and protection setting optimizer proposed is utilized to create optimal relay settings assuming conventional time overcurrent (TOC) elements exist at the protection device locations in FIGS. 5 to 8. In this case study, it is assumed that the IEEE 123 node system is first operating in Configuration 1 (FIG. 5). The APS sends the optimized settings to the TOC elements. Using PSS® CAPE, a coordination study is performed to identify any misoperations or CTI violations in the protection system. The coordination study includes applying different types of faults at different locations of the system and calculating the CTI between the backup and primary TOC elements for each fault scenario. The coordination study results showed that with the settings provided by the APS, no misoperations are observed. Moreover, all CTIs are above 0.2 sec, which shows that the system is well coordinated. The calculated CTIs for different fault scenarios are summarized in a cumulative distribution function (CDF) plot in FIG. 11. However, if the communication system fails and the configuration of system changes to Configuration 2, the TOC elements won't be able to receive updated settings from APS. Running the coordination study for IEEE 123 node system in Configuration 2 while using the settings that are suited for Configuration 1 returned 99 misoperations in addition to 5 CTI violations. Each misoperation case denotes that for a fault scenario, the backup element has operated faster than the primary element. This study shows that the failure of the communication system can highly impact the effectiveness of conventional APS. The results show that LAMP units can effectively provide a well-coordinated protection in the system by effectively estimating the DS topology and detecting fault types and zones with a very high accuracy after the fault occurs.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A secondary fault protection system for use in an electric power distribution network having a primary fault protection system in communication with a relay connected to circuit breaker comprising: a plurality of local adaptive modular protection (LAMP) units configured to provide fault protection when the primary fault protection system is inoperable; said LAMP units including a processor configured to identify a fault, the type of fault and fault zone; said LAMP units further including a digital output system that sends a signal to the circuit breaker when a LAMP unit detects a fault.

2. The system of claim 1 wherein each of said LAMP units operate in parallel with the primary protection system.

3. The system of claim 2 wherein each of said LAMP units provide primary protection for a predetermined zone associated with each of said LAMP units and each of said LAMP units provides backup protection for other LAMP units.

4. The system of claim 4 wherein a first and second zone is assigned to each LAMP unit, for said first protection zone 1 each of said LAMP units operates instantaneously and for said second protection zone each of said LAMP units operate with a predetermined delay.

5. The system of claim 4 wherein each of said LAMP units detect faults and identify the fault type based on prevailing circuit conditions.

6. The system of claim 5 wherein each of said LAMP units includes three main classifiers, said classifiers including a circuit topology estimator, fault type classifier, and fault zone classifier.

7. The system of claim 6 wherein each of said LAMP units includes an analog input system configured to collect three-phase voltage and current.

8. The system of claim 7 wherein each of said LAMP units includes a phasor calculator that determines the root-mean-square (RMS) value and phase angle of the three-phase voltage and current measurements.

9. The system of claim 8 wherein each of said LAMP units includes an active and reactive power calculator that receives input from a phasor calculator and sends prefault active and reactive power measured at the LAMP location to an SVM classifier which is used to determine the topology of the electric power distribution network.

10. A method of providing a secondary fault protection system for use in an electric power distribution network having a plurality of primary fault protection systems in communication with a relay, each of said relays connected to a local current transformer, a voltage transformer, and a circuit breaker, comprising the steps of: for each primary fault protection system providing a local adaptive modular protection (LAMP) unit configured to provide fault protection when the primary fault protection system is inoperable; said LAMP connects to a local current transformer, a voltage transformer and circuit breaker, each lamp unit including a processor configured to identify a fault, the type of fault and fault zone; said LAMP unit further including a digital output system that sends a signal to the circuit breaker when a LAMP unit detects a fault.

11. The system of claim 10 wherein each of said LAMP units operates in parallel with the primary protection system.

12. The system of claim 11 wherein each of said LAMP units provides primary protection for a predetermined zone associated with each of said LAMP units and each of said LAMP units provides backup protection for other LAMP units.

13. The system of claim 12 wherein a first and second zone is assigned to each LAMP unit, for said first protection zone 1 each of said LAMP units operates instantaneously and for said second protection zone each of said LAMP units operate with a predetermined delay.

14. The system of claim 13 wherein each of said LAMP units detect faults and identify the fault type based on prevailing circuit conditions.

15. The system of claim 14 wherein each of said LAMP units includes three main classifiers, said classifiers including a circuit topology estimator, fault type classifier, and fault zone classifier.

16. The system of claim 15 wherein each of said LAMP units includes an analog input system configured to collect phase voltage and current.

17. The system of claim 16 wherein each of said LAMP units includes a phasor calculator that determines the root-mean-square (RMS) value and phase angle of the three-phase voltage and current measurements.

18. The system of claim 17 wherein each of said LAMP units includes an active and reactive power calculator that receives input from a phasor calculator and sends prefault active and reactive power measured at the LAMP location to an SVM classifier which is used to determine the topology of the electric power distribution network.
